(19) United States
(12) Patent Application Publication
(10) Pub. No.: US 2006/0075667 A1
(43) Pub. Date: Apr. 13, 2006

(54) Illuminating device

(75) Inventors: Ralph Hubert Peters, Eindhoven (NL); Petrus Johannes Antonius Linssen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., THE NETERLANDS 5621 (NL)

(21) Appl. No.: 10/530,380

(22) PCT Filed: Sep. 19, 2003
(86) PCT No.: PCT/IB03/04180

§ 371 Date: Apr. 6, 2005

(30) Foreign Application Priority Data
Oct. 15, 2002 (EP) 02079192.7

(51) Int. Cl. G09F 13/20

(52) U.S. Cl. 40/542

(57) ABSTRACT

An illuminating device has light means for generating light and a light-emitter comprising an after-glowing material for emitting light after the light means is switched off or has extinguished. According to the invention, the light-emitter comprises a predetermined pattern for displaying information. Preferably, the intensity Ilm of the light emitted by the light means as compared to the intensity Ile of the light emitted by the light-emitter is such that Ile/Ilm<0.1, preferably Ile/Iim<00.1. Preferably, the pattern comprises an alphanumerical character, a logo and/or an arrow. The light-emitter is preferably provided on an electric lamp, on the light emission window of a luminaire or on a display window of a display device. The pattern remains visible after the light means has been switched off or has extinguished.

The invention relates to an illuminating device comprising light means for generating light and a light-emitter comprising an after-glowing material for emitting light after the light means is switched off or has extinguished.

In addition, the invention relates to an electric lamp comprising a lamp vessel provided with the light-emitter.

The invention further relates to a luminaire comprising a housing having a light-emission window, the housing or the light-emission window being provided with the light-emitter.

The invention further relates to an automotive head lamp comprising a housing having a light emission window, the housing or the light-emission window being provided with the light-emitter.

The invention also relates to a display device comprising a display window provided with the light-emitter.

Such illuminating devices are known per se. They are applied, inter alia, in so-called luminous signs, among other things, for advertising purposes, e.g. in shops, hotels, airports, etc. They can also be used in guiding boards as “exit”signs, in billboards, traffic lights, systems for guiding traffic flows and as (dashboard) lighting in vehicles. They can also be applied in automotive head lamps. Said illuminating devices are used both as interior lighting and exterior lighting.

An illuminating device of the kind mentioned in the opening paragraph is known from the English abstract of JP-A 11 73 804. The known illuminating device comprises a luminous light-emission layer formed on (the lens body of) a vehicle headlamp. After the headlight has been switched off, the light-emission layer comprises a luminous pigment with an after-glowing effect.

It is an object of the invention to improve the usability of the illuminating device. According to the invention, an illumination device of the kind mentioned in the opening paragraph is for this purpose characterized in that the light-emitter comprises a predetermined pattern for displaying information.

The inventors have had the insight that the light-emitter provided on the illuminating device can be shaped in the form of a pattern. The after-glowing material is applied to the illuminating device such that a predetermined pattern is obtained. The pattern is shaped such that information is displayed. The after-glowing material employs the light emitted by the light means (e.g. an electric lamp) or by another (natural) light source to activate the after-glowing effect. In addition, the light means may be the light emitted by (an image displayed on) a display device. The predetermined pattern remains visible for a certain amount of time after the power to the light means of the illuminating device has been switched off.

When the current supply to the light means is interrupted, for example in the case of a power failure caused by a calamity, or when part of the light means breaks down, for example when a filament bums through, or when the light means is turned off, the room in which the illuminating device is mounted, darkens. When such darkening is undesirable, for instance in case of an emergency, such darkening may lead to panic reactions and the persons having difficulty in finding their way in the dark, in particular when they have to leave the room. When the light means is shut down, visible light will still be emitted, due to the action of the after-glowing material. By shaping the light-emitter in a pattern valuable information can be displayed, for instance information indicating the emergency exits.

An additional advantage of a light-emitter comprising a predetermined pattern is that after switching off the light means, information localizing and/or identifying the object can be made visible, for instance the after-glowing material is shaped to form the brand or trade name of a company. This may for instance be important in order to localize the illuminating device in the darkened room.

A preferred embodiment of the illuminating device according to the invention is characterized in that the pattern comprises an alphanumerical character, a logo and/or an arrow. The pattern in which the after-glowing material is formed on the illuminating device may be, by way of example, a safety message, a logo and/or an arrow.

Preferably, the after-glowing material comprises a photo-luminescent or phosphorescent material.

The light-emitter may be visible when the light means is operational. In an alternative embodiment, the light-emitter becomes visible when the light means are switched off or when there is a general power failure. A preferred embodiment of the illuminating device according to the invention is characterized in that the intensity Iₗₘ of the light emitted by the light means as compared to the intensity Iₗₑ of the light emitted by the light-emitter is such that Iₗₑ/Iₗₘ<0.5. In this embodiment, the light-emitter is visible on the illuminating device when the light means is in operation, although at a relatively low level. Preferably, Iₗₑ/Iₗₘ<0.1. In this case the light-emitter is practically invisible when the light means is in operation. This is an advantageous embodiment in the event that the illuminating device is a display device provided with a light-emitter on the display screen.

An alternatively preferred embodiment of the illuminating device according to the invention is characterized in that the initial light output following the switching off or the extinguishing of the light means is lower than 3 cd/m². The initial light output of the light-emitter is such that the light-emitter is visible on the illuminating device when the light means is in operation, although at a relatively low level. Preferably, the initial light output is equal to or is lower than 1 cd/m². This is an advantageous embodiment in the event that the illuminating device is a display device provided with a light-emitter on the display screen.

The invention, in addition, relates to an electric lamp comprising a lamp vessel provided with a light-emitter as described hereinbefore. Any type of electric lamp may be employed in the illuminating device.

The invention further relates to a luminaire comprising a housing having a light-emission window, the housing or the light-emission window being provided with a light-emitter as described hereinbefore.

The invention further relates to an automotive head lamp comprising a housing having a light emission window, the housing or the light-emission window provided with a light-emitter as described hereinbefore.

The invention also relates to a display device comprising a display window, the display window being provided with a light-emitter as described hereinbefore.

The invention will now be explained in more detail with reference to a number of embodiments and a drawing, in which:

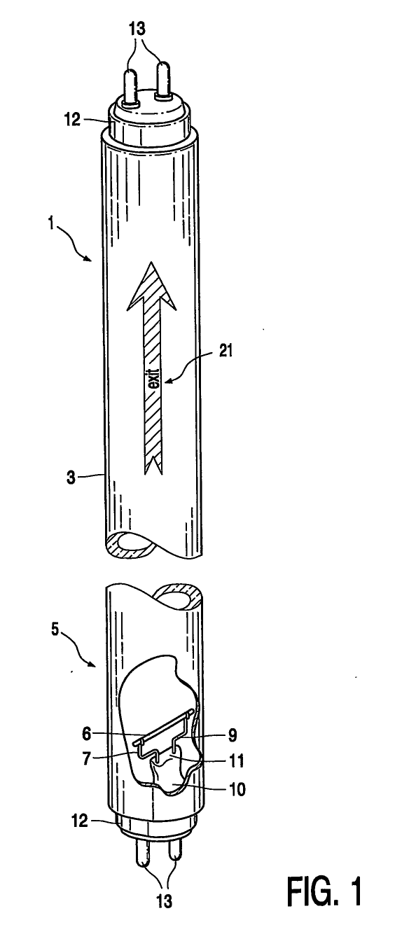

FIG. 1 shows a low-pressure mercury vapor discharge lamp provided with a light-emitter according to the invention;

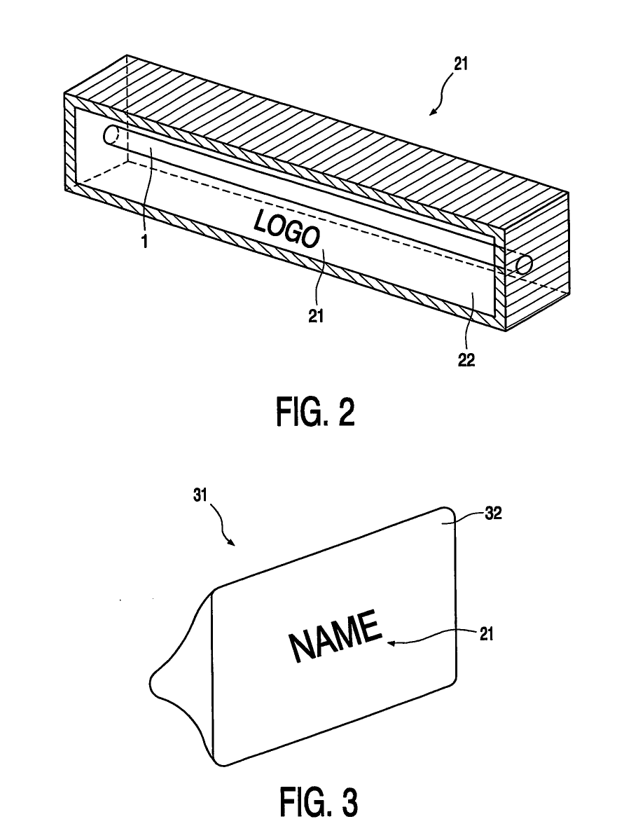

FIG. 2 shows a luminaire with a light-emission window provided with a light-emitter according to the invention, and FIG. 3 shows a display device with a display window provided with a light-emitter according to the invention.

The Figures are purely diagrammatic and not drawn true to scale. Some dimensions are particularly strongly exaggerated for reasons of clarity. Equivalent components have been given the same reference numerals as much as possible in the Figures.

FIG. 1 shows diagrammatically a low-pressure mercury discharge lamp 1 with an elongate glass discharge vessel 3, in this example a so-called 36 W TLD lamp with a diameter=25.4 mm ( 8/8inch) and length=1.20 m. The discharge lamp comprises an electrode 5 at each end, which electrode is formed by a tungsten incandescent coil 6 supported by conducting lead wires 7, 9 which extend through a glass pinch 11 which is provided on a glass stem 10. The incandescent coil 6 is provided with an emitter material such as oxides of barium, calcium, and strontium for reducing the work function of the electrode. The stem 10 hermetically seals off the discharge vessel 3. The lead wires 7, 9 are connected to pin-type contacts 13 in the respective end caps 12 which are provided at either end of the lamp 1. The discharge vessel 3 is filled with a rare gas mixture comprising one or several of the gases xenon, krypton, argon, and neon under a certain filling pressure. The discharge vessel 3 is further provided with a sufficient quantity of mercury. According to the invention, the discharge vessel is provided with a light-emitter 21 comprising a predetermined pattern. Preferably, the pattern comprises an alphanumerical character, a logo and/or an arrow. The pattern in which the after-glowing material is formed on the illuminating device may be, by way of example, a safety message (e.g. a warning), a logo (e.g. a brand name, a vignette of an organization promoting safety or promoting environmental issues) and/or an arrow (e.g. indicating an escape route). In the example of FIG. 1, the light-emitter comprises an arrow and the word “EXIT”.

Preferably, the intensity of the after-glowing material is such that the light-emitter is visible on the illuminating device when the light means is in operation. In that case the intensity Iₗₘ of the light emitted by the light means as compared to the intensity Iₗₑ of the light emitted by the light-emitter is such that Iₗₑ/Iₗₘ<0.5, preferably, Iₗₑ/Iₗₘ<0.1.

Preferably, the after-glowing material comprises a photo-luminescent or phosphorescent material. A suitable material is, for instance, a commercially available single component silicone with after-glowing properties, such as Yfestos®. Such a material can be applied easily to obtain a predetermined pattern. Other materials to be applied are the well-know fluorescence materials. The after-glowing material can be exposed to light having a wavelength range of approximately 350-450 nm. The wavelength range in which the after-glowing material, preferably, emits is 475-575 nm.

FIG. 2 shows diagrammatically a luminaire 21 with a light-emission window 22 provided with a light-emitter 21 according to the invention. In the example of FIG. 2 the luminaire comprises a low-pressure mercury vapor discharge lamp 1 and the light-emitter 21 according to the invention comprises a predetermined pattern comprising an arrow and a (company) logo.

FIG. 3 shows very diagrammatically a display device 31 with a display window 32 provided with a light-emitter 21 according to the invention. In the example of FIG. 3 the light-emitter 21 comprises a predetermined pattern comprising a (brand) name. In particular in the case of display device 31 provided with a light-emitter according to the invention, the light-emitter is preferably, practically invisible when the display device is in operation. In that case the intensity Iₗₘ of the light emitted by the light means as compared to the intensity Iₗₑ of the light emitted by the light-emitter is such that Iₗₑ/Iₗₘ<00.5.

The scope of the invention is not limited to the embodiments. The invention is embodied in each new characteristic and each combination of characteristics. Any reference sign do not limit the scope of the claims. The word “comprising” does not exclude the presence of other elements or steps than those listed in a claim. Use of the word “a” or “an” preceding an element does not exclude the presence of a plurality of such elements.

1. An illuminating device comprising light means for generating light and a light-emitter comprising an after-glowing material for emitting light after the light means is switched off or has extinguished, characterized in that the light-emitter comprises a predetermined pattern for displaying information.

2. An illuminating device as claimed in claim 1, characterized in that the intensity Iₗₘ of the light emitted. by the light means as compared to the intensity Iₗₑ of the light emitted by the light-emitter is such that Iₗₑ/Iₗₘ<0.5.

3. An illuminating device as claimed in claim 2, characterized in that Iₗₑ/Iₗₘ<0.1.

4. An illuminating device as claimed in claim 1, characterized in that the initial light output following the switching off or the extinguishing of the light means is lower than 3 cd/m².

5. An illuminating device as claimed in claim 4, characterized in that the initial light output is equal to or lower than 1 cd/m².

6. An illuminating device as claimed in claim 1, characterized in that the pattern comprises an alphanumerical character, a logo and/or an arrow.

7. An illuminating device as claimed in claim 1, characterized in that the after-glowing material comprises a photo-luminescent or phosphorescent material.

8. Electric lamp comprising a lamp vessel provided with a light-emitter according to claim 1.

9. Luminaire comprising a housing having a light emission window, the housing or the light-emission window being provided with a light-emitter according to claim 1.

10. Automotive head lamp comprising a housing having a light emission window, the housing or the light-emission window being provided with a light-emitter according to claim 1.

11. Display device comprising a display window provided with a light-emitter according to claim 1.
